(19) United States
(12) Patent Application Publication
(10) Pub. No.: US 2017/0265161 A1
(43) Pub. Date: Sep. 14, 2017

(54) INFORMATION PROVIDING APPARATUS, INFORMATION PROVIDING METHOD, DISPLAY CONTROL METHOD, AND DISPLAY CONTROL DEVICE

(71) Applicant: FUJITSU LIMITED, Kawasaki-shi (JP)

(72) Inventors: Takashi Watanabe, Kanazawa (JP); Kazuya Nozaki, Toyama (JP); Masahiro Shitashimo, Toyama (JP); Jun'ichi Kosaka, Takaoka (JP)

(73) Assignee: FUJITSU LIMITED, Kawasaki-shi (JP)

(21) Appl. No.: 15/433,239

(22) Filed: Feb. 15, 2017

(30) Foreign Application Priority Data
Mar. 8, 2016 (JP) 2016-044725

(51) Int. Cl. H04W 64/00; H04W 4/02

(52) U.S. Cl. CPC H04W 64/006; H04W 4/025

(57) ABSTRACT

An information providing apparatus includes: a memory; and a processor coupled to the memory, wherein the processor is configured to: receive information including a display condition that controls a display performed by a terminal device with use of a state of the terminal device; and provide the terminal device with the information received by the reception unit.

### CROSS-REFERENCE TO RELATED APPLICATION

This application is based upon and claims the benefit of priority of the prior Japanese Patent Application No. 2016-044725, filed on Mar. 8, 2016, the entire contents of which are incorporated herein by reference.

### FIELD

A certain aspect of the embodiments is related to an information providing apparatus, an information providing program, an information providing method, a display control program, a display control method, and a display control device.

### BACKGROUND

There have been known information providing apparatuses that provide information such as benefits to a terminal device by push notification as disclosed in, for example, Japanese Patent Application Publication Nos. 2014-006569 and 2014-215681. When the terminal device displays the information provided from the information providing apparatus, the user can visually recognizes the information.

### SUMMARY

According to a first aspect of the embodiments, there is provided an information providing apparatus including: a memory; and a processor coupled to the memory, wherein the processor is configured to: receive information including a display condition that controls a display performed by a terminal device with use of a state of the terminal device; and provide the terminal device with the received information.

According to a second aspect of the embodiments, there is provided a non-transitory computer readable storage medium storing a program that causes a computer to execute a process, the process including: receiving information including a display condition that controls a display performed by a terminal device with use of a state of the terminal device; and providing the terminal device with the received information.

According to a third aspect of the embodiments, there is provided an information providing method implemented by a computer, the information providing method including: receiving information including a display condition that controls a display performed by a terminal device with use of a state of the terminal device; and providing the terminal device with the received information.

According to a fourth aspect of the embodiments, there is provided a non-transitory computer readable storage medium storing a program that causes a terminal device including a sensor to execute a process, the process including: receiving display information and a display condition for displaying the display information; obtaining detection information detected by the sensor; determining whether the obtained detection information satisfies the received display condition; and displaying the received display information when the display condition is satisfied.

According to a fifth aspect of the embodiments, there is provided a display control method, implemented by a computer, of a terminal device including a sensor, the display control method including: receiving display information and a display condition for displaying the display information; obtaining detection information detected by the sensor; determining whether the obtained detection information satisfies the received display condition; and displaying the received display information when the display condition is satisfied.

According to a sixth aspect of the embodiments, there is provided a display control device of a terminal device including a sensor, the display control device including: a memory; and a processor coupled to the memory, wherein the processor is configured to: receive display information and a display condition for displaying the display information; obtain detection information detected by the sensor; determine whether the obtained detection information satisfies the received display condition; and display the received display information when the display condition is satisfied.

### BRIEF DESCRIPTION OF DRAWINGS

FIG. 1 is a diagram for describing an exemplary information providing system;

FIG. 2 illustrates an exemplary hardware configuration of a user terminal;

FIG. 3 illustrates an exemplary hardware configuration of a server;

FIG. 4 is a block diagram of the user terminal and the server;

FIG. 5 is a flowchart illustrating processes executed by the user terminal, the server, and an operator terminal;

FIG. 6 is a flowchart illustrating processes executed by the user terminal, the server, and the operator terminal;

FIG. 7 illustrates a display example of a message;

FIG. 8 illustrates another display example of a message;

FIG. 9 illustrates another display example of a message; and

FIG. 10 illustrates another display example of a message.

### DESCRIPTION OF EMBODIMENTS

If the information providing apparatus disclosed in, for example, Japanese Patent Application Publication Nos. 2014-006569 and 2014-215681 can periodically obtain from the terminal device the state of the terminal device (e.g., positional information and detected values by various sensors), the information providing apparatus can provide information efficiently in accordance with the state of the terminal device. However, if the terminal device periodically transmits the state thereof to the information providing apparatus, processing load and management burdens may increase in the information providing apparatus. In addition, the periodical transmission of the state of the terminal device may lead to the identification of user's state, and may arise security problems.

Hereinafter, a description will be given of embodiments for carrying out the present case with reference to the accompanying drawings.

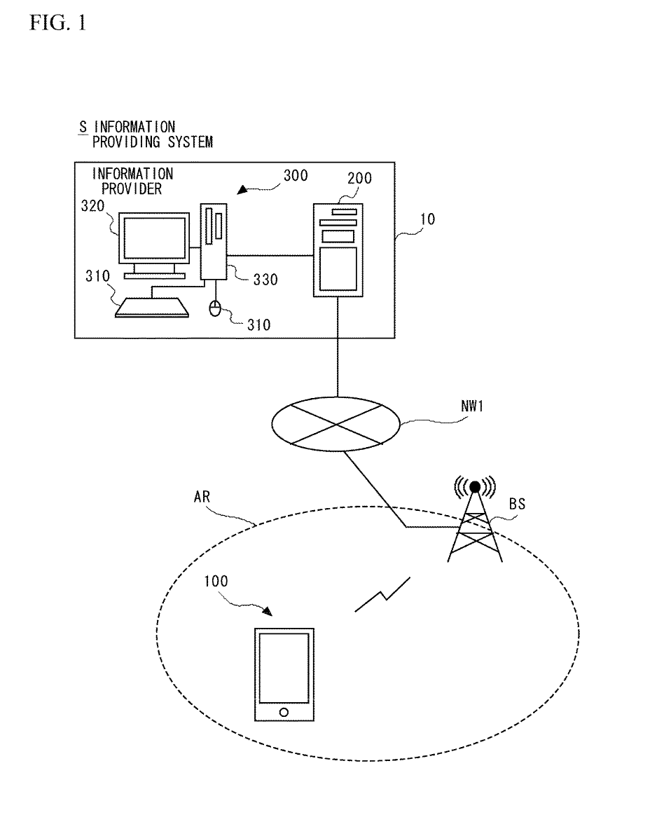

FIG. 1 is a diagram for describing an exemplary information providing system S. The information providing system S includes a user terminal 100 as a terminal device, and a server 200 as an information providing apparatus. Although FIG. 1 illustrates a handheld terminal representing a smartphone as an example of the user terminal 100, the user terminal 100 is not limited to a smartphone as long as the user terminal 100 is a handheld terminal. For example, a smart device such as a smart watch, a tablet terminal, and a wearable computer such as a head-mounted display may be used as a handheld terminal.

The user terminal 100 and the server 200 are connected via a wired network NW1 and a wireless network described later. The wired network NW1 is a communication network such as, for example, the Internet. The wireless network is a communication network such as, for example, a mobile telephone network. Thus, when the user terminal 100 is within a region AR in which the user terminal 100 can communicate over a radio, the user terminal 100 can communicate with the server 200.

The user terminal 100 receives various information transmitted from the server 200, and transmits various information to the server 200. For example, when the user terminal 100 transmits terminal information including terminal resource information, the server 200 receives the terminal information. The terminal resource information is information about terminal resources such as sensors, functions, and settings of the user terminal 100. In addition to the terminal resource information, the terminal information includes identification information for identifying a user, permission/prohibition information about permission or prohibition for the use of the terminal resources, and capability information about the capability of communication after the receipt of message information. Although a detailed description will be given later, the message information is an example of display information that the user terminal 100 can display.

A mobile phone base station BS receives the terminal information transmitted from the user terminal 100 via a wireless network. The mobile phone base station BS forwards the received terminal information to the server 200. The server 200 receives the terminal information forwarded by the mobile phone base station BS via the wired network NW1. When the server 200 receives the terminal information, the server 200 stores the terminal information, and transmits information indicating the completion of receipt to the user terminal 100. The detailed operation of the user terminal 100 will be described later.

The server 200 receives various information transmitted from the user terminal 100, and transmits various information to the user terminal 100. In addition, an operator terminal 300 is connected to the server 200. The operator terminal 300 includes an input unit 310 such as a keyboard and a mouse, a display 320 such as a liquid crystal display, and a controller 330 that controls the display 320 in accordance with the input from the input unit 310. The server 200 receives various information transmitted from the operator terminal 300, and transmits various information to the operator terminal 300 in response to a request from the operator terminal 300.

For example, when the operator terminal 300 transmits message information including a message to be provided to the user terminal 100, the server 200 receives the message information. The server 200 provides the received message information to the user terminal 100 by push notification. More specifically, the server 200 delivers or transmits the message information to the user terminal 100. The server 200 executes various processes in addition to the above-described processes, and the details of the processes will be described later.

In FIG. 1, the server 200 and the operator terminal 300 are included in a base 10 of an information provider, but the server 200 may be located in a base different from the base 10 of the information provider (for example, a data center on a cloud). The information provider may be, for example, distribution companies such as department stores and retail stores, or local public entities (or local governments) such as prefectures and municipalities.

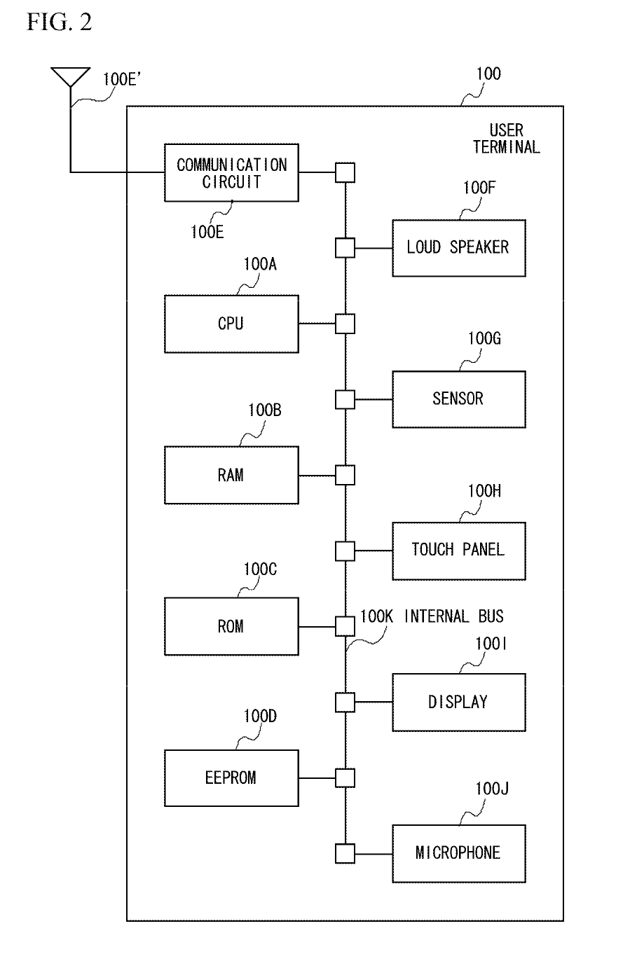

A description will next be given of a hardware configuration of the user terminal 100 with reference to FIG. 2.

FIG. 2 is an exemplary hardware configuration of the user terminal 100. As illustrated in FIG. 2, the user terminal 100 includes a Central Processing Unit (CPU) 100A, a Random Access Memory (RAM) 100B, a Read Only Memory (ROM) 100C, an Electrically Erasable Programmable Read Only Memory (EEPROM) 100D, and a communication circuit 100E. An antenna 100E′ is connected to the communication circuit 100E. Instead of the communication circuit 100E, a CPU that achieves communication functions may be utilized.

In addition, the user terminal 100 includes a loud speaker 100F, a sensor 100G, a touch panel 100H, a display 100I, and a microphone 100J. Examples of the sensor 100G include, but are not limited to, an illuminance sensor, an inclination sensor, an acceleration sensor, a magnetic sensor, a proximity sensor, a temperature sensor, a gyro sensor, a pressure sensor, an air temperature sensor, a humidity sensor, a rotational trajectory sensor, and a gravitational acceleration sensor. The CPU 100A through the microphone 100J are interconnected via an internal bus 100K. At least the cooperation between the CPU 100A and the RAM 100B achieves a computer.

The CPU 100A stores programs stored in the ROM 100C or the EEPROM 100D in the above-described RAM 100B. The execution of the stored programs by the CPU 100A implements various functions described later, and causes various processes to be executed. The program is written in accordance with a flowchart described later.

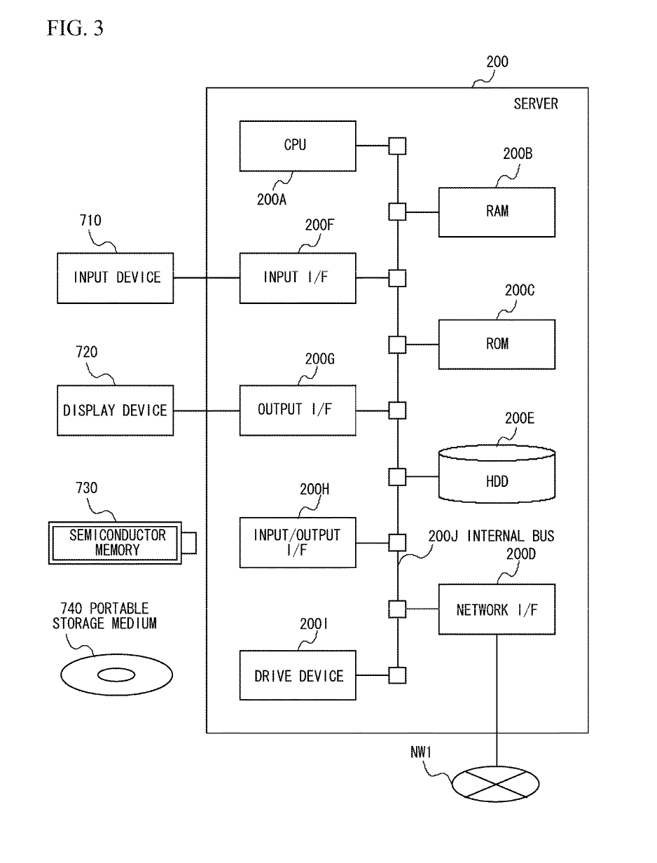

With reference to FIG. 3, a description will be given of a hardware configuration of the above-described server 200. The above-described operator terminal 300 basically has the same hardware configuration as the server 200, and thus the description thereof is omitted.

FIG. 3 illustrates an exemplary hardware configuration of the server 200. As illustrated in FIG. 3, the server 200 includes at least a CPU 200A, a RAM 200B, a ROM 200C, and a network LIF (interface) 200D. The server 200 may include at least one of a Hard Disk Drive (HDD) 200E, an input I/F 200F, an output LF 200G, an input/output I/F 200H, and a drive device 200I as necessary. The CPU 200A through the drive device 200I are interconnected via an internal bus 200J. At least the cooperation between the CPU 200A and the RAM 200B achieves a computer.

An input device 710 is connected to the input I/F 200F. Examples of the input device 710 include, but are not limited to, a keyboard and a mouse. A display device 720 is connected to the output I/F 200G. The display device 720 is, for example, a liquid crystal display. A semiconductor memory 730 is connected to the input/output I/F 200H. Examples of the semiconductor memory 730 include, but are not limited to, a Universal Serial Bus (USB) memory and a flush memory. The input/output I/F 200H reads programs and data stored in the semiconductor memory 730. The input I/F 200F and the input/output I/F 200H include, for example, a USB port. The output I/F 200G includes, for example, a display port.

A portable storage medium 740 is inserted to the drive device 200I. Examples of the portable storage medium 740 include, but are not limited to, a removable disc such as a Compact Disc (CD)-ROM and a Digital Versatile Disc (DVD). The drive device 200I reads programs and data stored in the portable storage medium 740. The network I/F 200D includes, for example, a port and a Physical Layer Chip (PHY chip). The server 200 is connected with the wired network NW1 via the network I/F 200D.

The CPU 200A stores programs stored in the ROM 200C or the HDD 200E in the above-described RAM 200B. The CPU 200A stores programs stored in the portable storage medium 740 in the RAM 200B. The execution of the stored programs by the CPU 200A allows the server 200 to achieve various functions described later and to execute various processes described later. The programs are written in accordance with the flowchart described later.

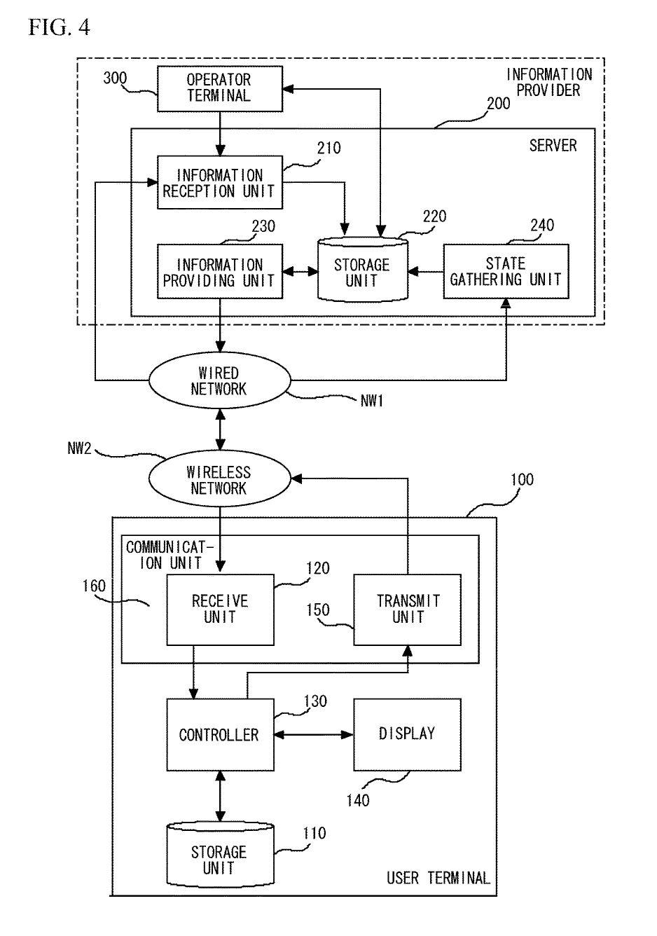

A description will next be given of functions of the user terminal 100 and the server 200 with reference to FIG. 4.

FIG. 4 is a block diagram of the user terminal 100 and the server 200. First, the user terminal 100 will be described. The user terminal 100 includes a storage unit 110, a receive unit 120, a controller 130 as a display control device, a display 140, and a transmit unit 150. The receive unit 120 and the transmit unit 150 are included in a communication unit 160. The communication unit 160 is, for example, the above-described communication circuit 100E and the antenna 100E′.

The storage unit 110 stores application programs (hereinafter, simply described as applications) and setting information. Examples of the applications include, but are not limited to, an application for implementing a Global Positioning System (GPS) function. Examples of the setting information include, but are not limited to, information about the setting of an incoming call mode. The storage unit 110 is, for example, the above-described EEPROM 100D.

The receive unit 120 receives the message information provided from the server 200. The message information includes a display condition that uses the state of the user terminal 100. Examples of the state of the user terminal 100 include, but are not limited to, positional information indicating the position of the user terminal 100, the environment of the location where the user terminal 100 is located (e.g., temperature, humidity, atmospheric pressure, illuminance, or the like), the setting made to the user terminal, and the magnitude of a force applied to the user terminal 100. The receive unit 120 outputs the received message information to the controller 130.

The controller 130 receives the message information output from the receive unit 120, and controls the display of the message information depending on whether the state of the user terminal 100 satisfies the above-described display condition. For example, when the display condition is one that permits to present the message information to a user who is within several kilometers from a store of a distribution company, the controller 130 obtains the positional information from the GPS, and determines whether the display condition is satisfied based on the obtained positional information. For example, when the display condition is one that permits to display the message information when the temperature and the humidity of a specific place are high, the controller 130 obtains the positional information and values or information (hereinafter, simply described as values) sensed or detected (hereinafter, simply described as sensed) by the temperature sensor and the humidity sensor, and determines whether the display condition is satisfied based on the obtained values. When the state of the user terminal 100 satisfies the display condition, the controller 130 executes the display of the message information. The controller 130 is, for example, the above-described CPU 100A.

The display 140 displays the message information by the control of the controller 130. For example, the display 140 may display information after excluding the display condition and predetermined information (for example, provided time and communication records) of the message information. This configuration allows a user to visually recognize the message without the display condition and the like. The display 140 is, for example, the above-described touch panel 100H and the display 100I.

The transmit unit 150 transmits the state of the user terminal 100. More specifically, the transmit unit 150 transmits a first state of the user terminal 100 when the display condition is not satisfied, or a second state of the user terminal 100 when the display condition is satisfied. That is, the transmit unit 150 transmits the first state or the second state representing the state at the time when the controller 130 determined the display condition. Furthermore, the transmit unit 150 transmits a third condition of the user terminal 100 when a predetermined period of time has elapsed after the second state was transmitted. That is, the transmit unit 150 transmits the third state representing the state after the message information was displayed.

Next, the server 200 will be described. The server 200 includes an information reception unit 210 as a reception unit, a storage unit 220, an information providing unit 230 as a providing unit, and a state gathering unit 240 as a gathering unit. As described above, the server 200 is coupled to the user terminal 100 through the wired network NW1 and a wireless network NW2.

The information reception unit 210 receives the message information from the operator terminal 300. As described above, the message information includes the display condition. The display condition is a condition that uses the state of the user terminal 100. More specifically, the display condition is a condition that controls the display executed by the user terminal 100 with use of the state of the user terminal 100. The message information is scripted by the operator terminal 300. That is, the message information is written in a script language. Examples of the script language include, but are not limited to, Java Script (registered trademark), VB Script, and Ajax. Since the message information is scripted, various messages and display conditions can be included in the message information. When the information reception unit 210 receives the message information, the information reception unit 210 stores the message information in the storage unit 220. The information reception unit 210 also receives the terminal information transmitted from the user terminal 100. The terminal information includes the terminal resource information. When the information reception unit 210 receives the terminal information, the information reception unit 210 stores the received terminal information in the storage unit 220.

The information providing unit 230 provides the user terminal 100 with the message information received by the information reception unit 210. More specifically, the information providing unit 230 provides the message information by push notification. Accordingly, the user terminal 100 receives the message information. Especially, since the information providing unit 230 provides the message information by push notification, an operator can select a desired timing at which the message information is delivered to a user and thereby provide the message information at the desired timing.

The state gathering unit 240 gathers the state of the user terminal 100 transmitted from the user terminal 100. The state of the user terminal 100 includes the above-described first state, second state, and third state. When the state gathering unit 240 gathers the state of the user terminal 100, the state gathering unit 240 stores the gathered state of the user terminal 100 in the storage unit 220. That is, the state gathering unit 240 stores the first state, the second state, and the third state.

Since the storage unit 220 stores the first state, the second state, and the third state, the operator terminal 300 can access the storage unit 220 to obtain the first state, the second state, and the third state. An operator who operates the operator terminal 300 can verify the effect of the provision of the message information by analyzing the obtained first state, second state, and third state. For example, by analyzing the state of the user terminal 100 when the message information was viewed and the state of the user terminal 100 after the message information was viewed, the action that the user took after viewing the message information can be identified. Especially, the state of the user terminal 100 includes a wide range of states such as values sensed by the sensors, positional information, and settings, and thus has a wide application. Therefore, the operator can perform a broad analysis and extend the analysis to general information.

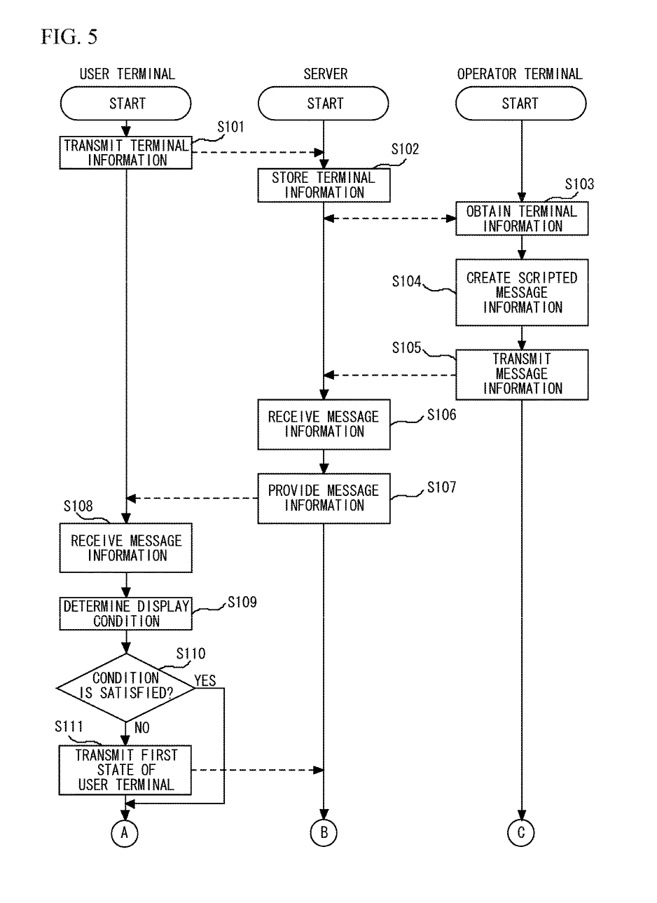

Next, with reference to FIG. 5 through FIG. 7, the operations of the user terminal 100, the server 200, and the operator terminal 300 will be described.

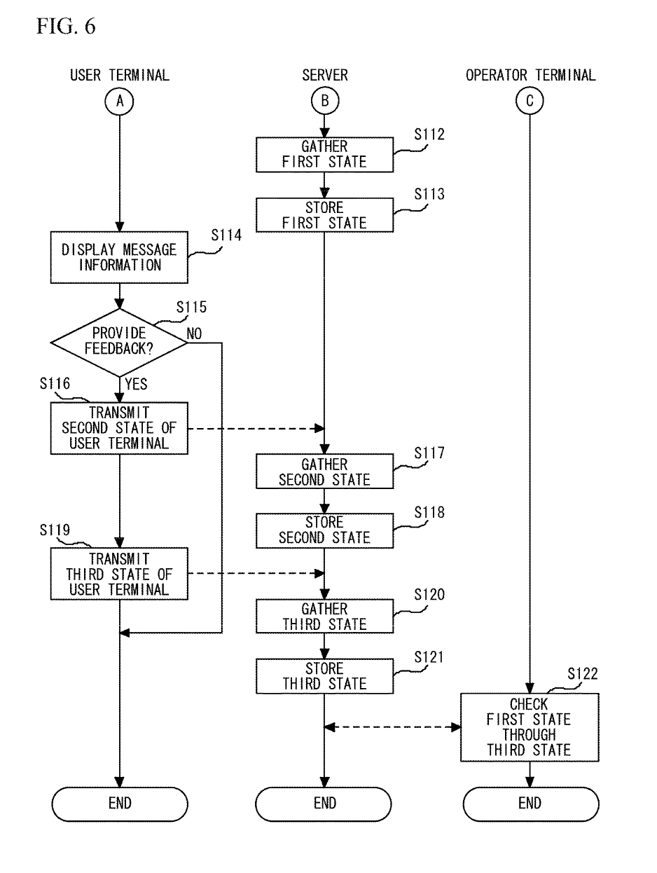

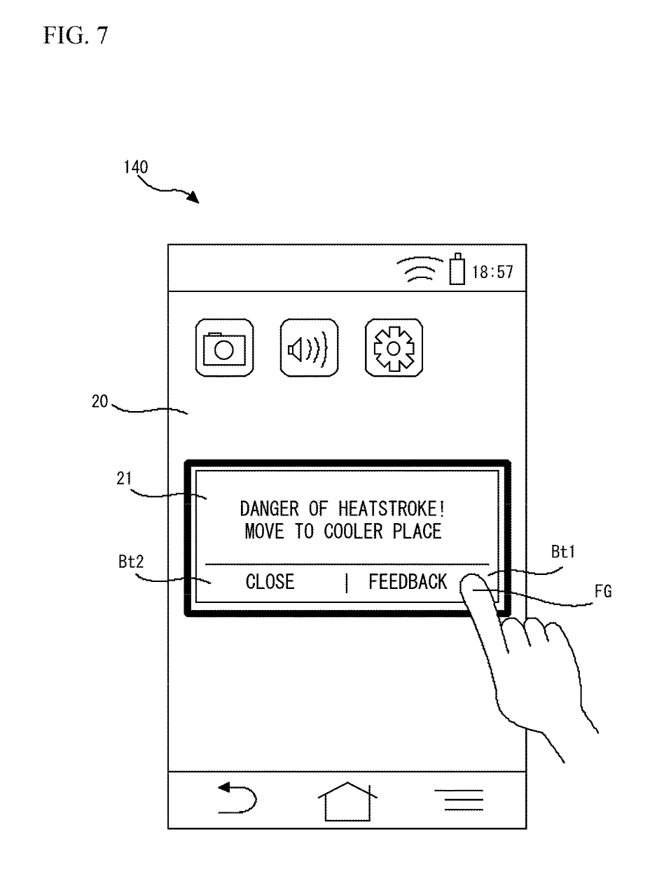

FIG. 5 and FIG. 6 are flowcharts illustrating processes executed by the user terminal 100, the server 200, and the operator terminal 300. FIG. 7 illustrates a display example of a message. As illustrated in FIG. 5, the transmit unit 150 of the user terminal 100 transmits the terminal information to the server 200 (step S101). When the process at step S101 is completed, the information reception unit 210 of the server 200 stores the terminal information transmitted from the user terminal 100 in the storage unit 220 (step S102). As already described, the terminal information includes the terminal resource information about the terminal resources such as the sensors, the functions, and the settings of the user terminal 100. Therefore, the server 200 can know the terminal resources of the user terminal 100.

When the process at step S102 is completed, the controller 330 of the operator terminal 300 obtains the terminal information from the storage unit 220 in accordance with the input from the input unit 310 (step S103), and creates the scripted message information (step S104). More specifically, the controller 330 creates the scripted message information including a message and the display condition for displaying the message on the user terminal 100 in accordance with the input from the input unit 310. The display condition includes items relating to, for example, a temperature, a humidity, an illuminance, a distance, and a setting, which are predetermined. The items included in the display condition are preferably associated with the terminal resources. For example, when the message information including the display condition that uses illuminance is transmitted to the user terminal 100 having no illuminance sensor, the controller 130 of the user terminal 100 cannot determine the display condition. Thus, by associating the display condition with the terminal resources, the server 200 does not need to provide unnecessary message information to the user terminal 100. In addition, when the use of a specific sensor is prohibited by the permission/prohibition information included in the terminal information, by setting the display condition that does not use the specific sensor, the information amount of the message information can be reduced compared to the case where the display condition that uses all the sensors is set.

When the process at step S104 is completed, the controller 330 then transmits the message information to the server 200 (step S105). When the process at step S105 is completed, the information reception unit 210 of the server 200 receives the message information (step S106), and the information providing unit 230 provides the message information to the user terminal 100 (step S107). More specifically, the information reception unit 210 stores the received message information in the storage unit 220, and the information providing unit 230 obtains the message information from the storage unit 220 and delivers or transmits the obtained message information.

When the process at step S107 is completed, the receive unit 120 of the user terminal 100 receives the message information (step S108), and the controller 130 determines the display condition (step S109). More specifically, the controller 130 analyzes the scripted message information, obtains at least one of the value sensed by the sensor 100G, positional information obtained through the GPS function implemented by the application stored in the storage unit 110, and setting information about the incoming call mode stored in the storage unit 110 to determine whether the display condition is satisfied.

When the controller 130 determines that the display condition is not satisfied (step S110: NO), the transmit unit 150 transmits the first state of the user terminal 100 to the server 200 (step S111). When the process at step S111 is completed, the process moves to FIG. 6, and the state gathering unit 240 of the server 200 gathers the first state transmitted from the user terminal 100 (step S112). The state gathering unit 240 stores the gathered first state in the storage unit 220 (step S113).

On the other hand, when the controller 130 determines that the display condition is satisfied, (step S110: YES), step S111 is skipped, and the display 140 displays the message information (step S114). That is, when the controller 130 determines that the display condition is not satisfied at step S110, the display 140 does not display the message information, while when the controller 130 determines that the display condition is satisfied, the display 140 displays the message information. Accordingly, as illustrated in FIG. 7, the display 140 displays a screen 21 (e.g., a dialogue) including a predetermined message so that the screen 21 is superimposed on a predetermined screen 20 (e.g., a standby screen or a home screen).

In FIG. 7, the display 140 displays the screen 21 because the value sensed by the temperature sensor is 38° C. when the display condition includes the instruction to display a message when the value sensed by a temperature sensor is greater than 35° C. The screen 21 contains a message that warns about the danger due to heatstroke and a message that requests an avoidance action. The display condition may be one that changes the display content depending on the sensed value. For example, when the sensed value is 32° C. or greater and 35° C. or less, a message warning about the danger due to heatstroke and a message recommending an avoidance action may be displayed. In addition, the screen 21 includes buttons Bt1 and Bt2 that are images that can be operated by a finger FG of the user. The button Bt1 contains predetermined characters “feedback”. The button Bt2 contains predetermined characters “close”.

Back to FIG. 6, when the process at step S114 is completed, the controller 130 of the user terminal 100 determines whether to provide feedback (step S115). More specifically, when the display 140 detects a touch operation (e.g., a tap operation) to the button Bt1 by the finger FG, the controller 130 determines to provide feedback (step S115: YES). In this case, the transmit unit 150 transmits the second state of the user terminal 100 to the server 200 (step S116). When transmitting the second state, the transmit unit 150 may transmit the display content together. When the process at step S116 is completed, the state gathering unit 240 of the server 200 gathers the second state transmitted from the user terminal 100 (step S117), and stores the second state in the storage unit 220 (step S118).

On the other hand, when the display 140 detects a touch operation to the button Bt2 by the finger FG, the controller 130 determines not to provide feedback (step S115: NO). In this case, the transmit unit 150 skips step S116 and step S119 described later. Thus, when the display 140 displays the screen 21 including the message, the server 200 can know the second state of the user terminal 100 at the time when the screen 21 has been displayed. When the display 140 does not detect touch operations to the button Bt1 or Bt2 by the finger FG for a predetermined period of time, the controller 130 may determine not to provide feedback.

When the process at step S116 is completed, the transmit unit 150 transmits the third state of the user terminal 100 to the server 200 (step S119). When the process at step S119 is completed, the state gathering unit 240 of the server 200 gathers the third state transmitted from the user terminal 100 (step S120), and stores the third state in the storage unit 220 (step S121). This process allows the server 200 to know the positional information of the user terminal 100 and the environment of the location that the user terminal 100 is located after the screen 21 was displayed.

When the process at step S121 is completed, the controller 330 of the operator terminal 300 checks the first state through the third state in accordance with the input from the input unit 310 (step S122). More specifically, the controller 330 accesses the storage unit 220 of the server 200, and obtains at least one of the first state through the third state. The operator can review the first state through the third state to analyze and evaluate the effect of the transmission of the message information. For example, the effect of the message information can be evaluated by reviewing whether the user moves to a cooler area because of the message information, or calculating a ratio of users who took an avoidance action because of the message information.

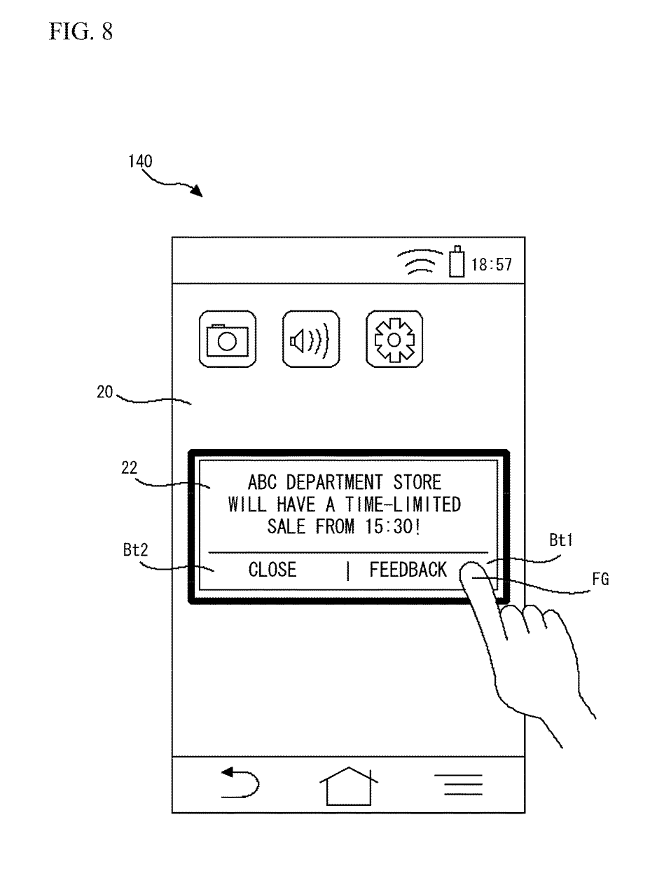

FIG. 8 illustrates another display example of a message. In FIG. 8, information on a time-limited sale by a distribution company is displayed. For example, the information providing unit 230 provides all the members of the distribution company with the message information that includes the display condition that allows the user terminals 100 located within a several kilometers from the stores of the distribution company to display the message. The controller 130 of the user terminal 100 held by the member determines the distance from the store with the positional information, and when the controller 130 determines that the display condition is satisfied, the display 140 displays a screen 22. The display condition may be one that changes the message appearing in the screen 22 depending on the distance from the store.

Furthermore, as illustrated in FIG. 8, when the button Bt1 is touched by the finger FG, the third state of the user terminal 100 is transmitted from the user terminal 100 to the server 200. The operator terminal 300 obtains the third state gathered by the server 200. The operator can evaluate the effect on marketing such as how many users actually visit the store because of the message information by reviewing the third state and compiling statistics.

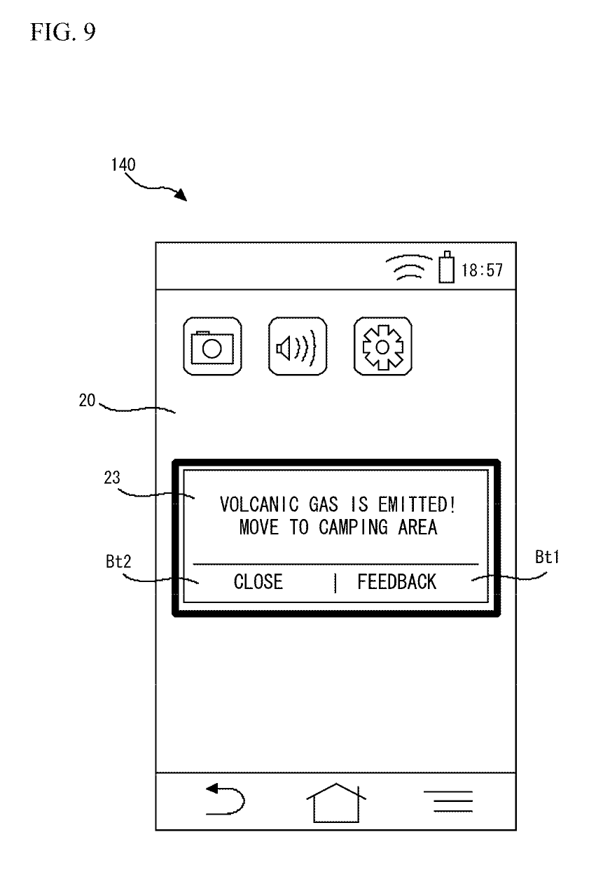

FIG. 9 illustrates another display example of a message. In FIG. 9, a force applied to the user terminal 100 is related to a volcanic gas alert by a local public entity. For example, the information providing unit 230 provides the user terminal 100 with the message information including the display condition that allows the user terminal 100 that is being located in a climbing prohibiting area such as the outside of a climbing trail or the outside of a camping area to display the message. The controller 130 of the user terminal 100 determines whether the user terminal 100 is located in a climbing prohibiting area with the positional information of the user terminal 100, and when the controller 130 determines that the display condition is satisfied, the display 140 displays a screen 23. The display condition may be one that changes the display content depending on the relationship between the positional information of the user terminal 100 and the content of the disaster or the location of the disaster.

Furthermore, when the buttons Bt1 and Bt2 are not touched by the finger FG for a predetermined period of time, the third state of the user terminal 100 is transmitted from the user terminal 100 to the server 200. For example, when a climber becomes unable to move by volcanic gas, the third state indicating that the acceleration sensor does not move for a predetermine period of time is transmitted. The operator terminal 300 obtains the third state gathered by the server 200. When an operator recognizes the third state, the operator makes phone calls to the climber, and requests an emergency service to the authority concerned if necessary. This example can be efficiently used for disaster relief.

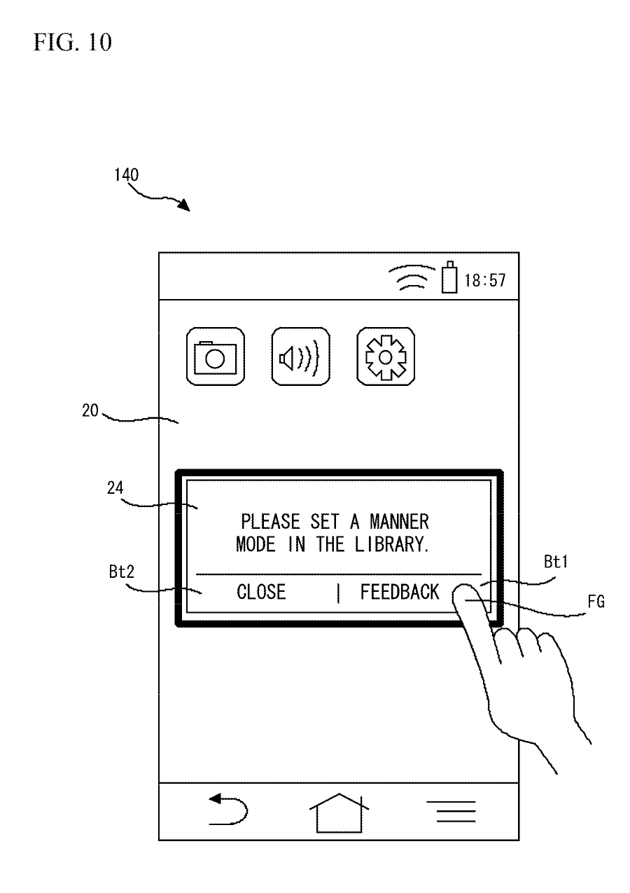

FIG. 10 illustrates another display example of a message. In FIG. 10, the incoming call mode setting of the user terminal 100 is related to manners inside the facility by a library. For example, the information providing unit 230 provides the user terminal 100 with the message information including the display condition that allows the user terminal 100 that is located in the library and of which the incoming call mode is not set to a manner mode to display a message. The controller 130 of the user terminal 100 determines whether the user terminal 100 is located inside the library with the positional information of the user terminal 100. The controller 130 also determines whether the manner mode is set with reference to the storage unit 110. When the controller 130 determines that the display condition is satisfied, the display 140 displays a screen 24 that calls for attention.

Furthermore, as illustrated in FIG. 10, when the button Bt1 is touched by the finger FG, the third state of the user terminal 100 is transmitted from the user terminal 100 to the server 200. The operator terminal 300 obtains the third state gathered by the server 200. An operator can evaluate the awareness of the manner of library users by using the message information calling for attention by reviewing the third state and checking whether a manner mode was set because of the message information. The location is not limited to the library as long as the quietness is required, and may be, for example, medical institutions, movie theaters, or concert halls.

As described above, in the present embodiment, the server 200 receives the message information including the display condition that controls the display performed by the user terminal 100 with use of the state of the user terminal 100, and provides the received message information to the user terminal 100. Accordingly, the display of the message information to be provided to the user terminal 100 can be controlled at the user terminal 100 side. That is, the determination of whether to display the message information is completed in the user terminal 100. In addition, since the user terminal 100 does not periodically (e.g., in real time) transmit the state of the user terminal 100, which changes from moment to moment, to the server 200, processing load and management burdens are unlikely to increase in the server 200. Furthermore, since the state of the user terminal 100 is not periodically transmitted, the security issue such as the identification of the state of the user can be avoided.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various change, substitutions, and alterations could be made hereto without departing from the spirit and scope of the invention.

What is claimed is:

1. An information providing apparatus comprising:
a memory; and
a processor coupled to the memory, wherein
the processor is configured to:
receive information including a display condition that controls a display performed by a terminal device with use of a state of the terminal device; and
provide the terminal device with the received information.

2. The information providing apparatus according to claim 1, wherein the processor is configured to gather a first state of the terminal device when the display condition is not satisfied, or a second state of the terminal device when the display condition is satisfied.

3. The information providing apparatus according to claim 2, wherein the processor is configured to further gather, when the second state has been gathered, a third state of the terminal device after the second state that has been gathered.

4. The information providing apparatus according to claim 1, wherein the display condition uses a terminal resource included in the terminal device.

5. The information providing apparatus according to claim 1, wherein the display condition uses as the state of the terminal device at least one of a value sensed by a sensor of the terminal device, positional information obtained through a GPS function of the terminal device, and an incoming call mode set to the terminal device.

6. The information providing apparatus according to claim 1, wherein the terminal device is a handheld terminal.

7. A non-transitory computer readable storage medium storing a program that causes a computer to execute a process, the process comprising:
receiving information including a display condition that controls a display performed by a terminal device with use of a state of the terminal device; and
providing the terminal device with the received information.

8. The non-transitory computer readable storage medium according to claim 7, wherein the process further comprises gathering a first state of the terminal device when the display condition is not satisfied, or a second state of the terminal device when the display condition is satisfied.

9. The non-transitory computer readable storage medium according to claim 8, wherein the process further comprises gathering, when the second state has been gathered, a third state of the terminal device after the second state that has been gathered.

10. The non-transitory computer readable storage medium according to claim 7, wherein the display condition uses a terminal resource of the terminal device.

11. The non-transitory computer readable storage medium according to claim 7, wherein the display condition uses as the state of the terminal device at least one of a value sensed by a sensor of the terminal device, positional information obtained through a GPS function of the terminal device, and an incoming call mode set to the terminal device.

12. The non-transitory computer readable storage medium according to claim 7, wherein the terminal device is a handheld terminal.

13. An information providing method implemented by a computer, the information providing method comprising:
receiving information including a display condition that controls a display performed by a terminal device with use of a state of the terminal device; and
providing the terminal device with the received information.

14. A non-transitory computer readable storage medium storing a program that causes a terminal device including a sensor to execute a process, the process comprising:
receiving display information and a display condition for displaying the display information;
obtaining detection information detected by the sensor;
determining whether the obtained detection information satisfies the received display condition; and
displaying the received display information when the display condition is satisfied.

15. The non-transitory computer readable storage medium according to claim 14, wherein the process comprises:
when the terminal device receives a plurality of pieces of the display information and the display conditions corresponding the plurality of pieces of the display information, determining whether the obtained detection information satisfies one of the received display conditions; and
when one of the display conditions is satisfied, displaying the display information corresponding to the one of the display conditions among the received plurality of pieces of the display information.

16. A display control method, implemented by a computer, of a terminal device including a sensor, the display control method comprising:
receiving display information and a display condition for displaying the display information;
obtaining detection information detected by the sensor;
determining whether the obtained detection information satisfies the received display condition; and
displaying the received display information when the display condition is satisfied.

17. A display control device of a terminal device including a sensor comprising:
a memory; and
a processor coupled to the memory, wherein
the processor is configured to:
receive display information and a display condition for displaying the display information;
obtain detection information detected by the sensor;
determine whether the obtained detection information satisfies the received display condition; and
display the received display information when the display condition is satisfied.

18. The display control device according to claim 17, wherein the processor is configured to:
when the terminal device receives a plurality of pieces of the display information and the display conditions of the plurality of pieces of the display information, determine whether the obtained detection information satisfies one of the received display conditions; and
when one of the display conditions is satisfied, display the display information corresponding to the one of the display conditions among the received plurality of pieces of the display information.
